(19) United States
(12) Patent Application Publication
(10) Pub. No.: US 2022/0407050 A1
(43) Pub. Date: Dec. 22, 2022

(54) TWO-DIMENSIONAL NI-ORGANIC FRAMEWORK/RGO COMPOSITE AND ELECTRODE FOR SECONDARY BATTERY OR SUPER-CAPACITOR COMPRISING SAME

(71) Applicant: CENTER FOR ADVANCED META-MATERIALS, Daejeon (KR)

(72) Inventors: Segi BYUN, Sejong (KR); Hyunuk KIM, Daejeon (KR); Seong Ok HAN, Daejeon (KR); Jungjoon YOO, Daejeon (KR); Tae Woo KIM, Daejeon (KR); Young-hoon SEONG, Daejeon (KR); Jatinder SINGH, Daejeon (KR); Hak Joo LEE, Daejeon (KR)

(73) Assignee: CENTER FOR ADVANCED META-MATERIALS, Daejeon (KR)

(21) Appl. No.: 17/775,105

(22) PCT Filed: Nov. 6, 2020
(86) PCT No.: PCT/KR2020/015547

§ 371 Date: May 6, 2022

(30) Foreign Application Priority Data
Nov. 7, 2019 (KR) 10-2019-0141386

(51) Int. Cl. H01M 4/36; H01M 4/60; H01M 4/587; H01M 10/0525; C07F 15/04; H01G 11/36

(52) U.S. Cl. CPC H01M 4/364; H01M 4/60; H01M 4/587; H01M 10/0525; C07F 15/045; H01G 11/36; H01M 2004/021

(57) ABSTRACT

The present disclosure relates to a two-dimensional Ni-organic framework/rGO composite including: a two-dimensional electroconductive Ni-organic framework in which Ni and an organic ligand containing a substituted or unsubstituted C₆-C₃₀ arylhexamine are repeatedly bonded in a branched form; and reduced graphene oxide (rGO). Thus, when a composite of reduced graphene oxide (rGO) and a two-dimensional Ni-MOF is prepared and used as an energy storage electrode material, the two-dimensional Ni-organic framework/rGO composite of the present disclosure can exhibit higher discharge capacity per weight due to the synergistic effect of rGO and Ni-MOF as compared to when Ni-MOF is used alone, and the composite can be used to manufacture a thin-film type electrode, which can be used as a next-generation energy storage electrode having high mechanical bending strength and energy density per volume.

### TECHNICAL FIELD

The present disclosure relates to a two-dimensional Ni-organic framework/rGO composite and an electrode for a secondary battery or a supercapacitor including the same.

### BACKGROUND ART

An electrostatic double-layer capacitor (EDLC) is a charge storage device which physically attaches ions on the surface of a conductive electrode. A supercapacitor having high capacitance is drawing a lot of attentions due to high power density, short charging time, low maintenance cost and long cycle life. In general, capacitance is proportional to the surface area of a conductive electrode. Therefore, activated carbon having large surface area has been commonly used as an electrode material. But, the relatively low energy density should be improved. In this regard, new pseudo-capacitive nanomaterials which store energy electrochemically through oxidation-reduction reactions on the surface have been studied extensively as electrodes that improve both power and energy density. Until now, transition metal oxides, conductive polymers and heteroatom-doped carbonaceous materials have been proposed as the pseudo-capacitive electrode materials. Among the various pseudo-capacitive nanomaterials, transition metal oxides have shown potential as electrode materials owing to high theoretical capacity, low cost and reversibility. In particular, inexpensive hybrid electrodes such as MnO₂/carbon and CoO/carbon have shown fast and stable oxidation-reduction reactions.

A metal-organic framework (MOF) consisting of metal ions and organic ligands have a well-aligned nanostructure with large surface area and high functionality. The secondary building units representing the point of extension in MOFs are mostly composed of metal oxide clusters. Therefore, the carbonization of MOFs under inert atmosphere generates metal oxides in carbonaceous materials. These materials have a large surface area with well dispersed metal oxides within the carbon framework.

Consequently, MOF-derived metal oxide/carbon has shown promising platform applications in clean energy. For example, Mn-MOF-derived Mn₂O₃/graphene showed a high specific capacitance of 471 Fg⁻¹ in 0.5 M Na₂SO₄ and long cycle stability.

Interestingly, the pyrolysis of MOFs under air or oxygen atmosphere produced well-defined metal oxides with enhanced pseudocapacitive properties. For example, mixed-metallic Co₃O₄/NiCo2O4 prepared by the pyrolysis of ZIF-67/Ni—Co LDH (layered double hydroxide) in air exhibited a high specific capacitance of 972 Fg⁻¹ at a current density of 5 Ag⁻¹.

A Ni-based two-dimensional metal-organic framework (2D Ni-MOF) is drawing a lot of attentions as an electrode material for next-generation secondary batteries and supercapacitors due to the inherently high electroconductivity and porosity and the possibility of oxidation and reduction of electrolyte ions and Ni without a further reduction process such as heat treatment and carbonization. But, because the 2D Ni-MOF exists in powder form, it is limited to be used as a battery electrode material capable of enduring mechanical bending and having high energy density per volume.

### DISCLOSURE

### Technical Problem

The present disclosure is directed to providing a two-dimensional Ni-organic framework/rGO composite. When a composite of reduced graphene oxide (rGO) and a two-dimensional Ni-MOF is prepared and used as an energy storage electrode material, the two-dimensional Ni-organic framework/rGO composite of the present disclosure can exhibit higher discharge capacity per weight due to the synergistic effect of rGO and Ni-MOF as compared to when Ni-MOF is used alone, and the composite can be used to manufacture a thin-film type electrode, which can be used as a next-generation energy storage electrode having high mechanical bending strength and energy density per volume.

### Technical Solution

In an aspect, the present disclosure provides a two-dimensional Ni-organic framework/rGO composite including: a two-dimensional electroconductive Ni-organic framework wherein an organic ligand containing substituted or unsubstituted C₆-C₃₀ arylhexamine and Ni are repeatedly bonded in a branched form; and reduced graphene oxide (rGO).

The two-dimensional Ni-organic framework/rGO composite may be used for use as one selected from a group consisting of a secondary battery electrode material, a supercapacitor electrode material and an electrochemical sensor material.

The substituted or unsubstituted C₆-C₃₀ arylhexamine may be one selected from substituted or unsubstituted benzenehexamine, substituted or unsubstituted naphthalenehexamine, substituted or unsubstituted anthracenehexamine, substituted or unsubstituted tetracenehexamine, substituted or unsubstituted pentacenehexamine, substituted or unsubstituted phenanthrenehexamine, substituted or unsubstituted pyrenehexamine, substituted or unsubstituted chrysenehexamine, substituted or unsubstituted perylenehexamine, substituted or unsubstituted fluorenehexamine, substituted or unsubstituted coronenehexamine and substituted or unsubstituted ovalenehexamine.

The substituted or unsubstituted C₆-C₃₀ arylhexamine may be one selected from the following compounds 1-7.

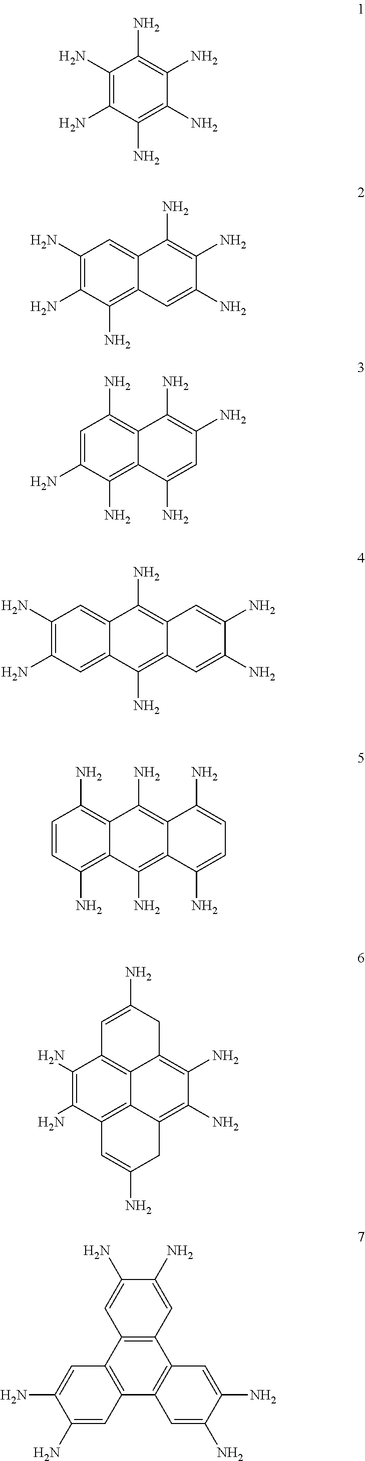

The two-dimensional Ni-organic framework/rGO composite may have an electroconductivity of 1-10,000 S/m at room temperature.

The two-dimensional Ni-organic framework/rGO composite may have a BET surface area of 10-3000 m²/g.

The two-dimensional Ni-organic framework/rGO composite may have a total pore volume of 0.1-5.0 m³/g.

The two-dimensional Ni-organic framework/rGO composite may include the two-dimensional Ni-organic framework and the rGO at a weight ratio of 1:0.3-1:1.5.

In another aspect, the present disclosure provides an electrode for a secondary battery or a supercapacitor, which includes the two-dimensional Ni-organic framework/rGO composite.

In another aspect, the present disclosure provides a method for preparing a two-dimensional Ni-organic framework/rGO composite, which includes:
(a) a step of preparing a two-dimensional Ni-organic framework dispersion wherein a two-dimensional Ni-organic framework in which an organic ligand containing a substituted or unsubstituted C₆-C₃₀ arylhexamine and Ni are repeatedly bonded in a branched form is dispersed in a solvent, and a graphene oxide dispersion wherein graphene oxide is dispersed in a solvent;
(b) a step of preparing a two-dimensional Ni-organic framework/GO mixture dispersion by mixing the two-dimensional Ni-organic framework dispersion and the graphene oxide dispersion;
(c) a step of separating the solvent from the two-dimensional Ni-organic framework/GO mixture dispersion and preparing a two-dimensional Ni-organic 15 framework/GO composite; and
(d) a step of preparing a two-dimensional Ni-organic framework/rGO composite by reducing the two-dimensional Ni-organic framework/GO composite through heat treatment.

The solvent may be one selected from methanol, ethanol, propanol, isopropyl alcohol (IPA), dimethyl sulfoxide (DMSO), dimethylformamide (DMF), N-methyl-2-pyrrolidone (NMP), dimethylacetamide (DMAC) and triethyl phosphate (TEP).

The substituted or unsubstituted C₆-C₃₀ arylhexamine may be one selected from substituted or unsubstituted benzenehexamine, substituted or unsubstituted naphthalenehexamine, substituted or unsubstituted anthracenehexamine, substituted or unsubstituted tetracenehexamine, substituted or unsubstituted pentacenehexamine, substituted or unsubstituted phenanthrenehexamine, substituted or unsubstituted pyrenehexamine, substituted or unsubstituted chrysenehexamine, substituted or unsubstituted perylenehexamine, substituted or unsubstituted fluorenehexamine, substituted or unsubstituted coronenehexamine and substituted or unsubstituted ovalenehexamine.

The substituted or unsubstituted C₆-C₃₀ arylhexamine may be one selected from the following compounds 1-7.

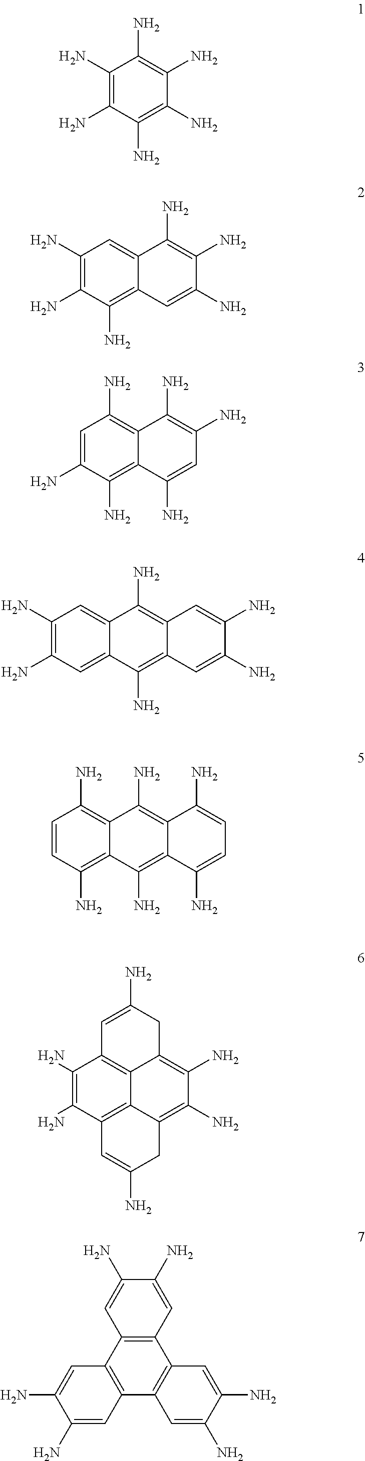

In the step (b), the two-dimensional Ni-organic framework/GO mixture dispersion may be prepared by mixing the two-dimensional Ni-organic framework dispersion and the graphene oxide dispersion at a weight ratio of 1:0.3-1:1.5.

In the step (b), the mixing may be performed by mechanical mixing or ultrasonic mixing.

In the step (c), the two-dimensional Ni-organic framework/GO composite may be prepared into a thin film using membrane filter paper.

The membrane filter paper may be made of a material selected from cellulose acetate, nitrocellulose, cellulose ester, polytetrafluoroethylene, polysulfone, polyether sulfone, polyacrilonitrile, polyamide, polyimide, polyethylene, polypropylene, polyvinylidene fluoride (PVDF) and polyvinyl chloride.

In the step (d), the heat treatment may be performed at 150-250° C.

In the step (d), the heat treatment may be performed for 0.5-2 hours.

In the step (d), the heat treatment may be performed under atmosphere of one selected from nitrogen gas, argon gas, nitrogen/hydrogen mixture gas and argon/hydrogen mixture gas.

In another aspect, the present disclosure provides a method for preparing an electrode for a secondary battery or a supercapacitor, which includes the method for preparing a two-dimensional Ni-organic framework/rGO composite.

### Advantageous Effects

The present disclosure is directed to providing a two-dimensional Ni-organic framework/rGO composite. When a composite of reduced graphene oxide (rGO) and a two-dimensional Ni-MOF is prepared and used as an energy storage electrode material, the two-dimensional Ni-organic framework/rGO composite of the present disclosure can exhibit higher discharge capacity per weight due to the synergistic effect of rGO and Ni-MOF as compared to when Ni-MOF is used alone, and the composite can be used to manufacture a thin-film type electrode, which can be used as a next-generation energy storage electrode having high mechanical bending strength and energy density per volume.

### BRIEF DESCRIPTION OF DRAWINGS

FIG. 1 shows a flow chart of a method for preparing a two-dimensional Ni-organic framework/rGO composite according to the present disclosure.

FIG. 2 shows a process of preparing a Ni-MOF/rGO thin film in Example 1.

FIG. 3 shows the surface SEM images of 2D Ni-MOF (left) and rGO (right).

FIG. 4 shows the magnified SEM image (left) and magnified SEM image (right) of a 2D Ni-MOF/rGO composite.

FIG. 5 shows the cross-sectional SEM image of a 2D Ni-MOF/rGO composite (left) and the cross-sectional SEM image of rGO (right).

FIG. 6 shows the X-ray diffraction (XRD) analysis result of Test Example 3.

FIGS. 7 and 8 show the N₂ adsorption isotherms obtained in Test Example 4.

FIG. 9 and FIG. 10 shows the charge-discharge evaluation result of Test Example 4.

### BEST MODE

The present disclosure may be changed variously and may have various exemplary embodiments. Hereinafter, the present disclosure will be described in detail through specific exemplary embodiments. However, it should be understood that the present disclosure is not limited to specific exemplary embodiments but encompasses all changes, equivalents and substitutes included in the scope of the present disclosure. In the following description of the present disclosure, detailed description of well-known technology may be omitted to avoid unnecessarily obscuring the subject matter of the present disclosure.

The expression “substituted” means substitution of at least one hydrogen atom by a substituent selected from a group consisting of deuterium, a C₁-C₃₀ alkyl group, a C₃-C₃₀ cycloalkyl group, a C₂-C₃₀ heterocycloalkyl group, a C₁-C₃₀ haloalkyl group, a C₆-C₃₀ aryl group, a C₁-C₃₀ heteroaryl group, a C₁-C₃₀ alkoxy group, a C₃-C₃₀ cycloalkoxy group, a C₁-C₃₀ heterocycloalkoxy group, a C₂-C₃₀ alkenyl group, a C₂-C₃₀ alkynyl group, a C₆-C₃₀ aryloxy group, a C₁-C₃₀ heteroaryloxy group, a silyloxy group (—OSiH₃), —OSiR¹H₂(R¹ is a C₁-C₃₀ alkyl group or a C₆-C₃₀ aryl group), —OSiR¹R²H (each of R¹ and R² is independently a C₁-C₃₀ alkyl group or a C₆-C₃₀ aryl group), —OSiR¹R²R³ (each of R¹, R² and R³ is independently a C₁-C₃₀ alkyl group or a C₆-C₃₀ aryl group), a C₁-C₃₀ acyl group, a C₂-C₃₀ acyloxy group, a C₂-C₃₀ heteroaryloxy group, a C₁-C₃₀ sulfonyl group, a C₁-C₃₀ alkylthio group, a C₃-C₃₀ cycloalkylthio group, a C₁-C₃₀ heterocycloalkylthio group, a C₆-C₃₀ arylthio group, C₁-C₃₀ heteroarylthio group, a C₁-C₃₀ phosphamide group, a silyl group (SiR¹R²R³) (each of R¹, R² and R³ is independently a hydrogen atom, a C₁-C₃₀ alkyl group or a C₆-C₃₀ aryl group), an amine group (—NRR′) (each of R and R′ is independently a substituent selected from a group consisting of a hydrogen atom, a C₁-C₃₀ alkyl group and a C₆-C₃₀ aryl group), a carboxyl group, a halogen group, a cyano group, a nitro group, an azo group and a hydroxy group.

In addition, two adjacent substituents among them may be fused to form a saturated or unsaturated ring.

The “amine group” may include an amino group, an arylamine group, an alkylamine group, an arylalkylamine group or an alkylarylamine group and may be expressed as —NRR′ (each of R and R′ is independently a substituent selected from a group consisting of a hydrogen atom, a C₁-C₃₀ alkyl group and a C₆-C₃₀ aryl group).

The “aryl group” includes a monocyclic or fused polycyclic (i.e., rings sharing adjacent pairs of carbon atoms) functional group.

In the aryl group, the number of atoms in the ring is the sum of the numbers of carbon atoms and non-carbon atoms.

Hereinafter, the two-dimensional Ni-organic framework/rGO composite of the present disclosure is described.

The two-dimensional Ni-organic framework/rGO composite of the present disclosure includes: a two-dimensional electroconductive Ni-organic framework wherein an organic ligand containing a substituted or unsubstituted C₆-C₃₀ arylhexamine and Ni are repeatedly bonded in a branched form; and reduced graphene oxide (rGO).

The two-dimensional Ni-organic framework/rGO composite may be used for use as one selected from a secondary battery electrode material, a supercapacitor electrode material and an electrochemical sensor material.

The substituted or unsubstituted C₆-C₃₀ arylhexamine may be substituted or unsubstituted benzenehexamine, substituted or unsubstituted naphthalenehexamine, substituted or unsubstituted anthracenehexamine, substituted or unsubstituted tetracenehexamine, substituted or unsubstituted pentacenehexamine, substituted or unsubstituted phenanthrenehexamine, substituted or unsubstituted pyrenehexamine, substituted or unsubstituted chrysenehexamine, substituted or unsubstituted perylenehexamine, substituted or unsubstituted fluorenehexamine, substituted or unsubstituted coronenehexamine, substituted or unsubstituted ovalenehexamine, etc.

Specifically, the substituted or unsubstituted C₆-C₃₀ arylhexamine may be selected from the following compounds 1-7.

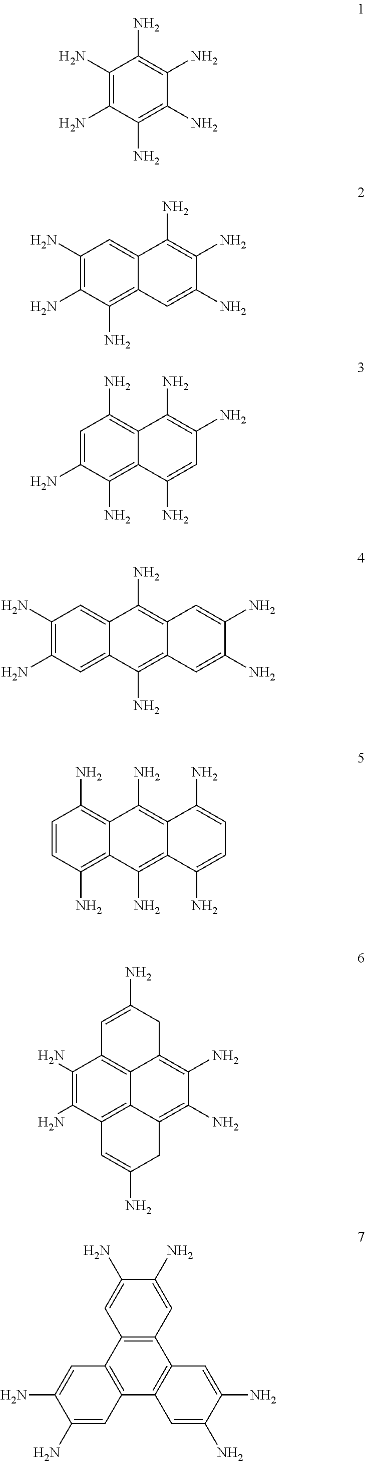

The two-dimensional Ni-organic framework/rGO composite may have an electroconductivity of 1-10,000 S/m at room temperature.

The two-dimensional Ni-organic framework/rGO composite may have a BET surface area of 10-3,000 m²/g.

The two-dimensional Ni-organic framework/rGO composite may have a total pore volume of 0.1-5.0 cm³/g.

Specifically, the two-dimensional Ni-organic framework/rGO composite may include the two-dimensional Ni-organic framework and the rGO at a weight ratio of 1:0.3-1:1.5, more specifically at a weight ratio of 1:0.5-1:1.

The present disclosure provides an electrode for a secondary battery or a supercapacitor, which includes the two-dimensional Ni-organic framework/rGO composite.

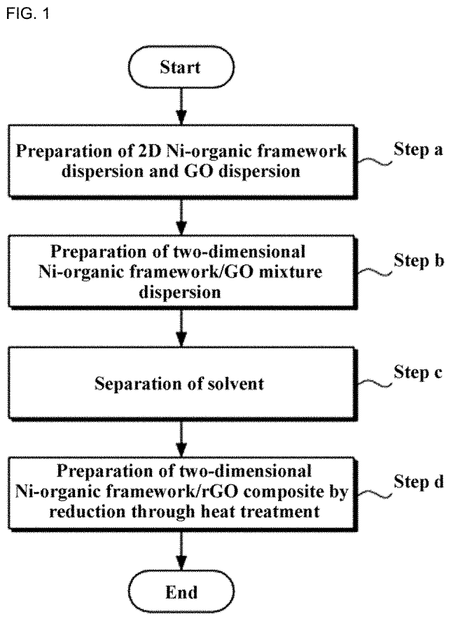

FIG. 1 shows a flow chart of a method for preparing a two-dimensional Ni-organic framework/rGO composite thin film according to the present disclosure. Hereinafter, the method for preparing a two-dimensional Ni-organic framework/rGO composite thin film according to the present disclosure will be described referring to FIG. 1.

First, a dispersion wherein a two-dimensional electroconductive Ni-organic framework in which an organic liqand containinq a substituted or unsubstituted C₆-C₃₀ arylhexamine and Ni are repeatedly bonded in a branched form is dispersed in a solvent. and a dispersion wherein qraphene oxide is dispersed in a solvent are prepared (step The solvent may be methanol, ethanol, propanol, isopropyl alcohol (IPA), dimethyl sulfoxide (DMSO), dimethylformamide (DMF), N-methyl-2-pyrrolidone (NMP), dimethylacetamide (DMAC), triethyl phosphate (TEP), etc.

Specifically, the substituted or unsubstituted C₆-C₃₀ arylhexamine may be substituted or unsubstituted benzenehexamine, substituted or unsubstituted naphthalenehexamine, substituted or unsubstituted anthracenehexamine, substituted or unsubstituted tetracenehexamine, substituted or unsubstituted pentacenehexamine, substituted or unsubstituted phenanthrenehexamine, substituted or unsubstituted pyrenehexamine, substituted or unsubstituted chrysenehexamine, substituted or unsubstituted perylenehexamine, substituted or unsubstituted fluorenehexamine, substituted or unsubstituted coronenehexamine, substituted or unsubstituted ovalenehexamine, etc.

More specifically, the substituted or unsubstituted C₆-C₃₀ arylhexamine may be one selected from the following compounds 1-7.

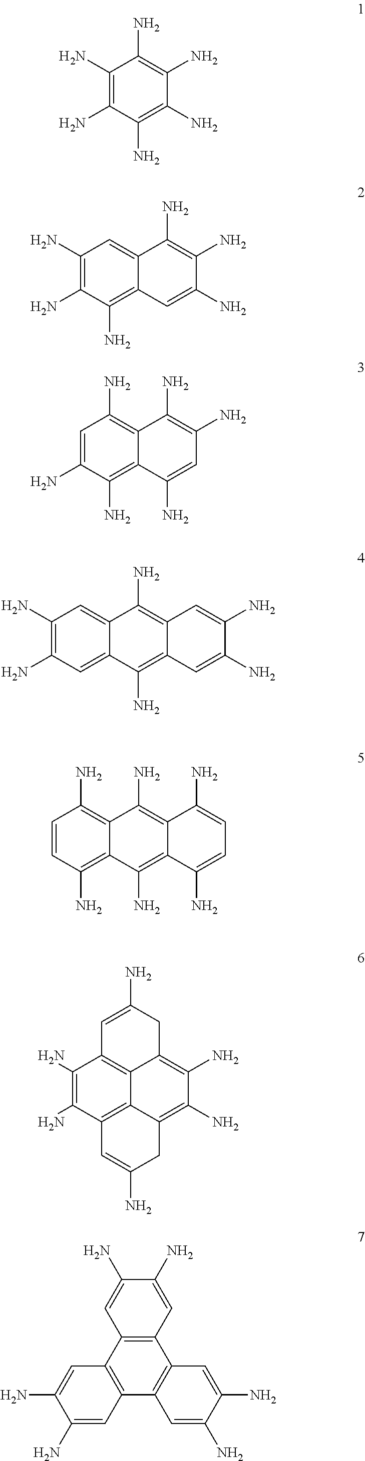

Next, a two-dimensional Ni-organic framework/GO mixture dispersion is prepared by mixing the two-dimensional Ni-organic framework dispersion and the graphene oxide dispersion (step b).

Specifically, the two-dimensional Ni-organic framework/GO mixture dispersion may be prepared by mixing the two-dimensional Ni-organic framework dispersion and the graphene oxide dispersion at a weight ratio of 1:0.3-1:1.

The mixing may be performed by mechanical mixing or ultrasonic mixing.

Subsequently, the solvent is separated from the two-dimensional Ni-orqanic framework/GO mixture dispersion and a two-dimensional Ni-orqanic framework/GO composite is prepared (step c).

The two-dimensional Ni-organic framework/GO composite may be prepared into a thin film using membrane filter paper.

The membrane filter paper may be made of cellulose acetate, nitrocellulose, cellulose ester, polytetrafluoroethylene, polysulfone, polyether sulfone, polyacrilonitrile, polyamide, polyimide, polyethylene, polypropylene, polyvinylidene fluoride (PVDF), polyvinyl chloride, etc.

Finally, a two-dimensional Ni-orqanic framework/rGO composite is prepared by reducing the two-dimensional Ni-orqanic framework/GO composite through heat treatment (step d).

The heat treatment may be performed at 150-250° C., more specifically at 170-230° C., further more specifically at 180-220° C.

The heat treatment may be performed 0.5-2 hours, more specifically for 0.7-1.5 hours, further more specifically for 0.8-1.2 hours.

The heat treatment may be performed under atmosphere of one selected from nitrogen gas, argon gas, nitrogen/hydrogen mixture gas and argon/hydrogen mixture gas.

The present disclosure provides a method for preparing an electrode for a secondary battery or a supercapacitor, which includes the method for preparing a two-dimensional Ni-organic framework/rGO composite.

Although it was not explicitly described in the following examples, one-dimensional electroconductive Ni-organic frameworks were prepared according to the method for preparing a two-dimensional Ni-organic framework/rGO composite thin film according to the present disclosure while varying the arylhexamine and the solvent in the step (a), the aryltetraamine and the mixing weight ratio of the two-dimensional Ni-organic framework dispersion and the graphene oxide dispersion in the step (b), and the heat treatment temperature and time and gas conditions in the step (d).

As a result of testing the electrochemical characteristics of electrodes including the prepared two-dimensional Ni-organic framework/rGO composites, high energy density was achieved only when all of the following conditions were satisfied. The preparation conditions are as follows.

In step (a), ethanol is used as the solvent and nickel nitrate is used as a nickel precursor. In the step (b), dimethyl sulfoxide (DMSO) is used as an organic solvent, one of the compounds 1-7 is used as the arylhexamine, and the two-dimensional Ni-organic framework dispersion and the graphene oxide dispersion are mixed at a weight ratio of 1:0.3-1:1.5. In the step (d), the heat treatment is performed at 150-250° C. for 0.5-2 hours under nitrogen gas atmosphere.

### MODE FOR INVENTION

### Examples

### Example 1: Preparation of Ni-MOF/rGO Thin Film

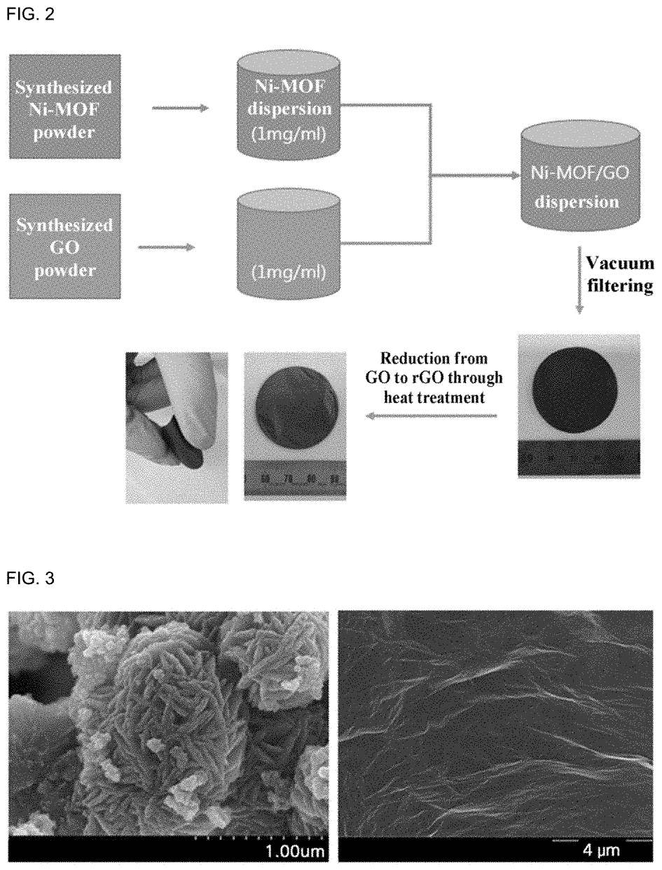

FIG. 2 shows a process of preparing a Ni-MOF/rGO thin film in Example 1. The method for preparing the Ni-MOF/rGO thin film of Example 1 will be described referring to FIG. 2.

### (1) Preparation of 2D Ni-MOF

2D Ni-HITP powder, which is 2D Ni-MOF, was prepared according to the known method. In a 20-mL scintillation vial, a solution of Ni(NO₃)₂·6H₂O (32 mg, 0.11 mmol) and 14 M NH₄OH (0.7 mL) dissolved in 3 mL of deaerated DMSO was added to a solution of HITP.6HCl (39 mg, 0.07 mmol) dissolved in 3 mL of deaerated DMSO. The vial was capped loosely and then heated at 60° C. for 2 hours without stirring. The mixture was centrifuged, transferred to a new container, washed twice with deionized water and then washed once with acetone. Ni₃(HITP)₂ (HITP=hexaaminotriphenylene) was obtained by drying the solid product in vacuo.

The reaction scheme is as follows.

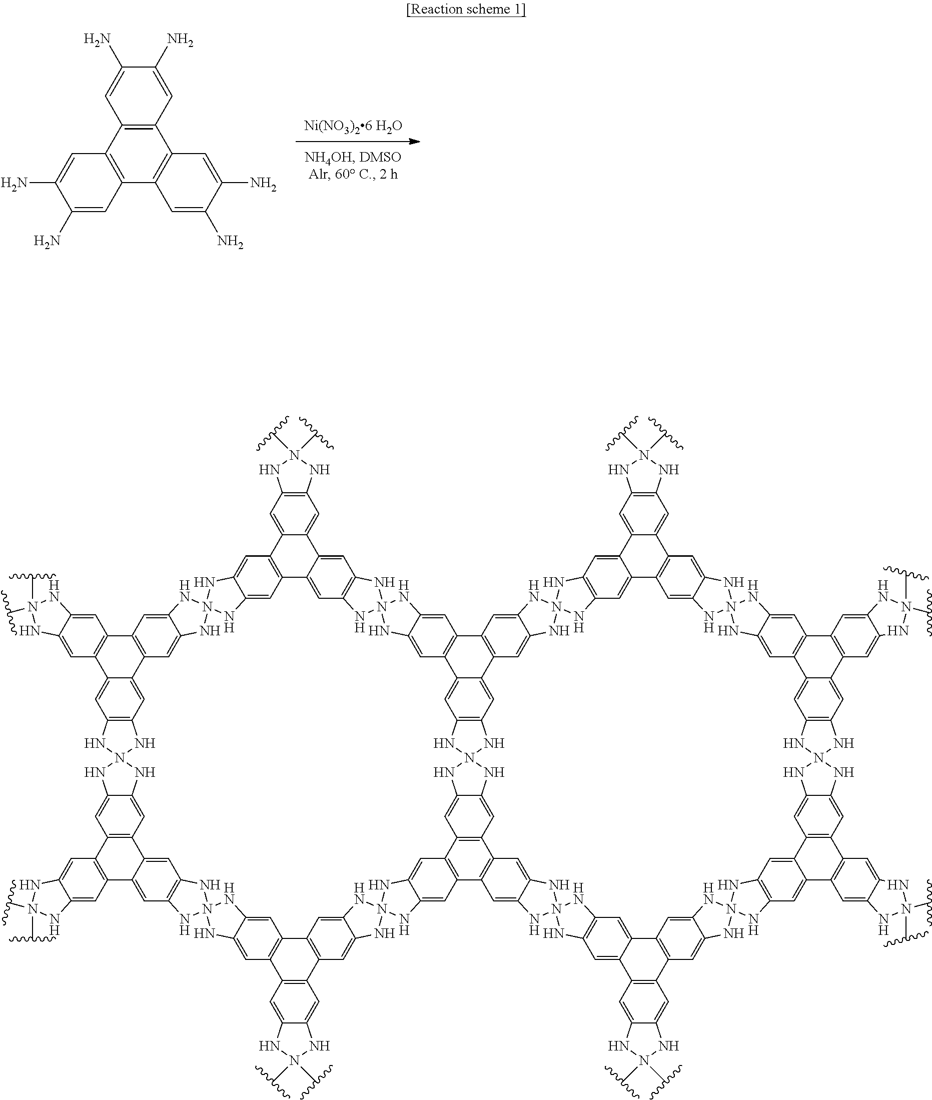

### (2) Preparation of Ni-MOF/rGO Composite Thin-Film Electrode

A Ni-MOF dispersion was prepared by dispersing Ni-MOF in ethanol, which is a solvent wherein the Ni-MOF powder is not dissolved, to a concentration of 1 mg/mL. Meanwhile, after preparing graphene oxide (GO) by Hummer's method, a GO dispersion was prepared by sonicating a predetermined amount of GO in a 20% aqueous ethanol solution. After slowly injecting the Ni-MOF dispersion and the GO dispersion at a weight ratio of 1:1, the two solutions were mixed by sonication. After completely separating the solvent from the prepared mixture solution using PTFE filter paper and a vacuum filter dryer, the pTFE filter was removed and a 2D Ni-MOF/GO thing film was prepared. By reducing the Ni-MOF/GO thin film through heat treatment at 200° C. for 1 hour under N₂ gas atmosphere using a furnace, the GO lacking electroconductivity was converted to a reduced form, rGO, and a 2D Ni-MOF/rGO composite thin-film electrode with superior electroconductivity was prepared finally.

### Comparative Example 1: 2D Ni-MOF Thin Film

A thin-film electrode was prepared in the same manner as in Example 1 except that the composition with rGO was not performed in (2).

### Comparative Example 2: 2D Ni-MOF+Super P+PTFE Electrode

2D Ni-MOF powder was prepared by pulverizing 2D Ni-MOF prepared according to Comparative Example 1. Then, the powder and Super P, which is conductive carbon, was mixed at 1:1 in a mortar. After mixing the mixture of Ni-MOF and Super P with a PTFE binder at a weight ratio of 8:2, an electrode was prepared by compressing in a mortar. The prepared electrode was compressed to a thickness of about 150 μm using a roller.

### Comparative Example 3: rGO Thin-Film Electrode

An electrode was prepared in the same manner as in Example 1 except that rGO was used instead of the Ni-MOF/rGO composite.

### Test Examples

### Test Example 1: Measurement of SEM Images and Electroconductivity

FIG. 3 shows the surface SEM images of the 2D Ni-MOF of Comparative Example 1 (left) and the rGO of Comparative Example 3 (right).

For the 2D Ni-MOF, spherical particles with a size of a few micrometers were formed as starfish-shaped two-dimensional structures were aggregated. In contrast, for the rGO thin film, rGO nanosheets with a width of several to tens of micrometers were overlapped to form a paper-like thin film with a smooth surface with no particle thereon.

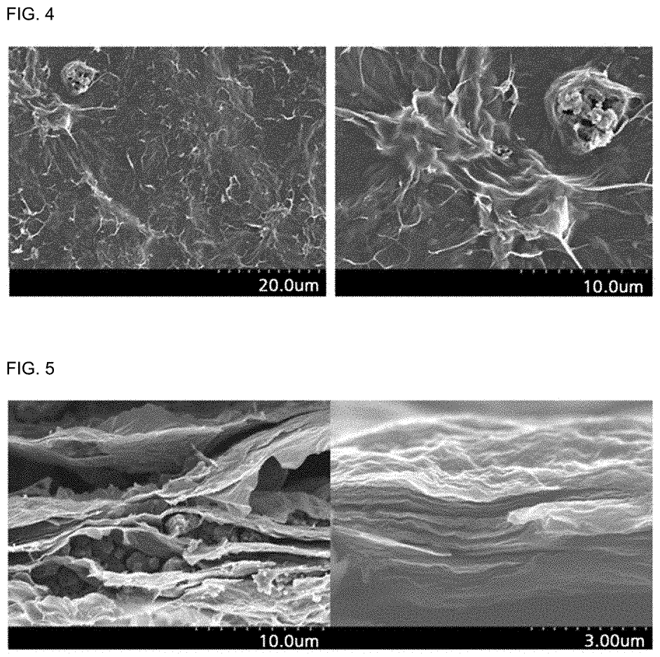

FIG. 4 shows the magnified SEM image (left) and magnified SEM image (right) of the 2D Ni-MOF/rGO composite of Example 1.

It can be seen that, for the 2D Ni-MOF/rGO composite, 2D Ni-MOF particles were stacked and distributed uniformly throughout the entire surface of rGO nanosheets.

FIG. 5 shows the cross-sectional SEM image of the 2D Ni-MOF/rGO composite (left) and the cross-sectional SEM image of the rGO (right).

It can be seen that, for the 2D Ni-MOF/rGO composite, 2D Ni-MOF nanoparticles may be interposed between rGO nanosheets.

### Test Example 2: Measurement of Electroconductivity

The electroconductivity measurement result for the thin-film electrodes prepared in Example 1 and Comparative Examples 1 and 3 is summarized in Table 1.

TABLE

| | Bulk resistance | | Thick- | Resis- | Electro- |
|---|---|---|---|---|---|
| | (mΩ · cm²)/sheet | | ness | tivity | conductivity |
| Sample | resistance (Ω/square) | | (μm) | (Ω · m) | (S/m) |
| Comp. Ex. 1 | 13756.271 | mΩ · cm² | 795 | 1.73 | 0.578 |
| (2D Ni-MOF) | | | | | |
| Comp. Ex. 3 | 11100 | Ω/square | 5 | 555 | 180.18 |
| (rGO) | | | | | |
| Ex. 1 (2D | 17400 | Ω/square | 6 | 1044 | 95.8 |
| Ni-MOF/rGO) | | | | | |

For the 2D Ni-MOF, which exists in powder form, powder pallets were prepared by compressing the same and bulk resistance was measured using a 2-point probe. The resistivity and electroconductivity of the rGO and the 2D Ni-MOF/rGO were measured by the general 4-point probe method after preparing micrometer-sized thin-film samples.

### Test Example 3: X-Ray Diffraction (XRD) Analysis

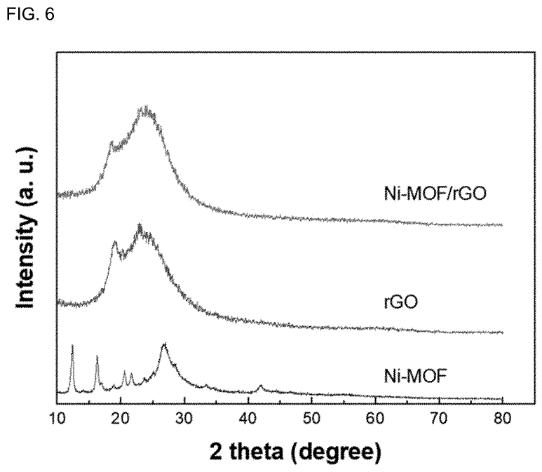

FIG. 6 shows the X-ray diffraction (XRD) analysis result for the 2D Ni-MOF of Comparative Example 1, the rGO of Comparative Example 3 and the 2D Ni-MOF/rGO composite of Example 1.

For the Ni-MOF/rGO composite, the rGO peak around 23° was shifted to around 24-25°, suggesting that Ni-MOF was interposed between rGO nanosheets and acted as a spacer that increase the spacing between the rGO nanosheets. In addition, the various peaks of Ni-MOF were not observed, which suggests that the 2D Ni-MOF was exfoliated or nanoparticulated.

### Test Example 4: Measurement of N₂ Adsorption Isotherms

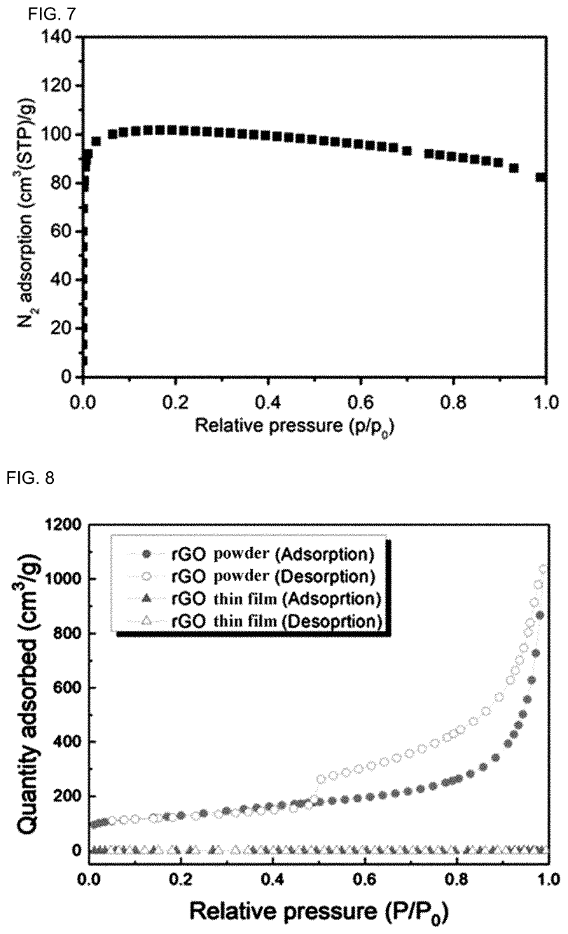

FIGS. 7 and 8 show the N₂ adsorption isotherms obtained in Test Example 4. FIG. 7 shows the measurement result for the 2D Ni-MOF of Comparative Example 1, and FIG. 8 shows the measurement result depending on the type of the rGO of Comparative Example 3.

For the 2D Ni-MOF, BET surface area could be measured as 401 m²/g using N₂ gas. But, for the 2D Ni-MOF/rGO composite thin film, it was difficult to measure surface area by the BET method because it has a thin-film structure like rGO and gas cannot be adsorbed sufficiently. The rGO powder has a BET surface area of 459 m²/g and the rGO thin film has a BET surface area of 10 m²/g. For the 2D Ni-MOF/rGO composite thin film of Example 1, which includes both 2D Ni-MOF and rGO, is thought to have a similar BET surface area of about 400-450 m²/g.

### Test Example 5: Evaluation of Charge-Discharge Characteristics

After cutting each of the electrodes prepared in Example 1, Comparative Example 2 and Comparative Example 3 to a size corresponding to about 1-5 mg, a secondary battery coin cell was prepared using the cut electrode, lithium foil, a glass fiber separator, a 1 M LiPF₆ EC/DMC electrolyte and a commercially available 2032 coin cell and the characteristics of the secondary battery was evaluated.

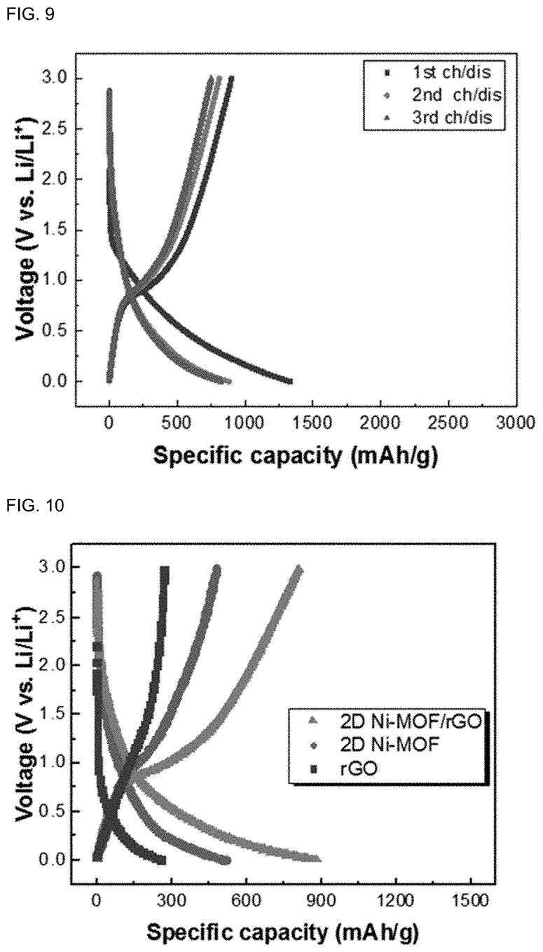

A lithium half-cell was assembled for electrochemical evaluation of the 2D Ni-MOF/rGO electrode prepared in Example 1. The charge-discharge curve for initial cycles was obtained in a voltage range of 0.0-3.0 V (vs. Li⁺/Li) at a C-rate of 50 mA/g, which is shown in FIG. 9. The charge-discharge capacity was divided by the total electrode weight.

For the first cycle, the charge-discharge capacity was 899.6 (charging) and 881.2 mAh g⁻¹ and the coulombic efficiency (CE) was 97.9%. For the second cycle, the charge-discharge capacity was 810/807.0 mAh g⁻¹ and the coulombic efficiency was 99.6%.

The charge-discharge curves of the electrodes prepared in Example 1, Comparative Example 2 and Comparative Example 3 obtained for electrochemical evaluation are shown in FIG. 10. For the electrode of Example 1, the charge-discharge capacity for the first cycle was 504.1/518.4 mAh g⁻¹ and the coulombic efficiency (CE) was 102.7%. For the second cycle, the charge-discharge capacity was 481.2/500.0 mAh g⁻¹ and the coulombic efficiency was 103%. Comparative Example 2 showed lower charge-discharge capacity than Example 1.

For the rGO thin-film electrode of Comparative Example 3, the charge-discharge capacity for the first cycle was 273.0/260.9 mAh g⁻¹ and the coulombic efficiency (CE) was 95.6%. And, for the second cycle, the charge-discharge capacity was 214.2/208.6 mAh g⁻¹ and the coulombic efficiency was 97.4%. That is to say, the electrode of Example 1 showed significantly higher charge-discharge capacity and coulombic efficiency as compared to the electrodes of Comparative Examples 2 and 3.

Although the specific exemplary embodiments of the present disclosure have been described above, those having ordinary knowledge in the art will be able to make various changes and modifications by addition, changing, deletion, annexation, etc. of elements without departing from the scope of the present disclosure. It is to be noted that such changes and modifications are encompassed in the scope of the present disclosure.

### INDUSTRIAL APPLICABILITY

The present disclosure is directed to providing a two-dimensional Ni-organic framework/rGO composite. When a composite of reduced graphene oxide (rGO) and a two-dimensional Ni-MOF is prepared and used as an energy storage electrode material, the two-dimensional Ni-organic framework/rGO composite of the present disclosure can exhibit higher discharge capacity per weight due to the synergistic effect of rGO and Ni-MOF as compared to when Ni-MOF is used alone, and the composite can be used to manufacture a thin-film type electrode, which can be used as a next-generation energy storage electrode having high mechanical bending strength and energy density per volume.

We claim:

1. A two-dimensional Ni-organic framework/rGO composite comprising: a two-dimensional electroconductive Ni-organic framework wherein an organic ligand comprising substituted or unsubstituted C₆-C₃₀ arylhexamine and Ni are repeatedly bonded in a branched form; and reduced graphene oxide (rGO).

2. The two-dimensional Ni-organic framework/rGO composite according to claim 1, wherein the two-dimensional Ni-organic framework/rGO composite is used for use as one selected from a group consisting of a secondary battery electrode material, a supercapacitor electrode material and an electrochemical sensor material.

3. The two-dimensional Ni-organic framework/rGO composite according to claim 1, wherein the substituted or unsubstituted C₆-C₃₀ arylhexamine is one selected from substituted or unsubstituted benzenehexamine, substituted or unsubstituted naphthalenehexamine, substituted or unsubstituted anthracenehexamine, substituted or unsubstituted tetracenehexamine, substituted or unsubstituted pentacenehexamine, substituted or unsubstituted phenanthrenehexamine, substituted or unsubstituted pyrenehexamine, substituted or unsubstituted chrysenehexamine, substituted or unsubstituted perylenehexamine, substituted or unsubstituted fluorenehexamine, substituted or unsubstituted coronenehexamine and substituted or unsubstituted ovalenehexamine.

4. The two-dimensional Ni-organic framework/rGO composite according to claim 3, wherein the substituted or unsubstituted C₆-C₃₀ arylhexamine is one selected from the following compounds 1-7:

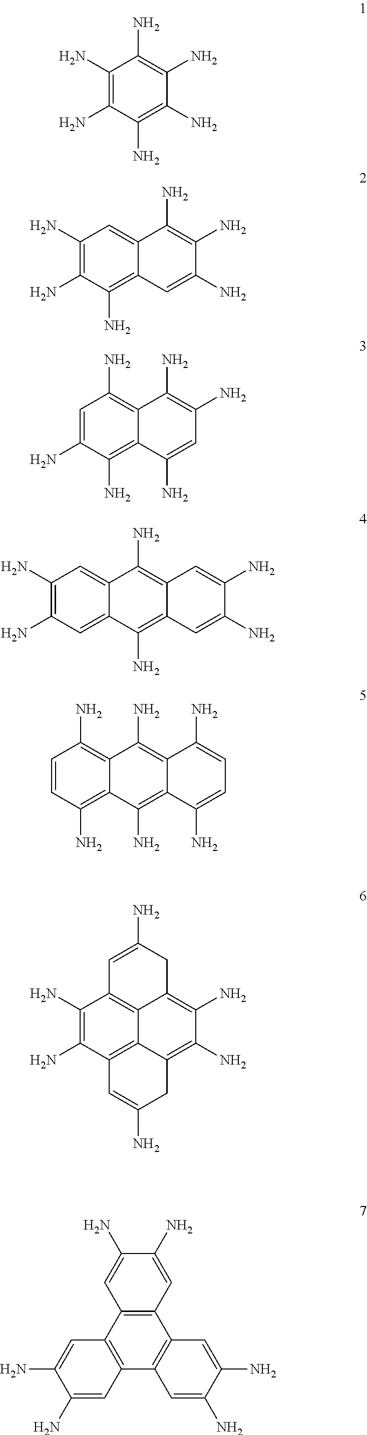

5. The two-dimensional Ni-organic framework/rGO composite according to claim 3, wherein the two-dimensional Ni-organic framework/rGO composite has an electroconductivity of 1-10,000 S/m at room temperature.

6. The two-dimensional Ni-organic framework/rGO composite according to claim 1, wherein the two-dimensional Ni-organic framework/rGO composite has a BET surface area of 10-3,000 m²/g.

7. The two-dimensional Ni-organic framework/rGO composite according to claim 1, wherein the two-dimensional Ni-organic framework/rGO composite has a total pore volume of 0.1-5.0 m³/g.

8. The two-dimensional Ni-organic framework/rGO composite according to claim 7, wherein the two-dimensional Ni-organic framework/rGO composite comprises the two-dimensional Ni-organic framework and the rGO at a weight ratio of 1:0.3-1:1.5.

9. An electrode for a secondary battery or a supercapacitor, comprising the two-dimensional Ni-organic framework/rGO composite according to claim 1.

10. A method for preparing a two-dimensional Ni-organic framework/rGO composite, comprising:
(a) a step of preparing a two-dimensional Ni-organic framework dispersion wherein a two-dimensional Ni-organic framework in which an organic ligand containing a substituted or unsubstituted C₆-C₃₀ arylhexamine and Ni are repeatedly bonded in a branched form is dispersed in a solvent, and a graphene oxide dispersion wherein graphene oxide is dispersed in a solvent;
(b) a step of preparing a two-dimensional Ni-organic framework/GO mixture dispersion by mixing the two-dimensional Ni-organic framework dispersion and the graphene oxide dispersion;
(c) a step of separating the solvent from the two-dimensional Ni-organic framework/GO mixture dispersion and preparing a two-dimensional Ni-organic framework/GO composite; and
(d) a step of preparing a two-dimensional Ni-organic framework/rGO composite by reducing the two-dimensional Ni-organic framework/GO composite through heat treatment.

11. The method for preparing a two-dimensional Ni-organic framework/rGO composite according to claim 10, wherein the solvent is one selected from methanol, ethanol, propanol, isopropyl alcohol (IPA), dimethyl sulfoxide (DMSO), dimethylformamide (DMF), N-methyl-2-pyrrolidone (NMP), dimethylacetamide (DMAC) and triethyl phosphate (TEP).

12. The method for preparing a two-dimensional Ni-organic framework/rGO composite according to claim 10, wherein the substituted or unsubstituted C₆-C₃₀ arylhexamine is one selected from substituted or unsubstituted benzenehexamine, substituted or unsubstituted naphthalenehexamine, substituted or unsubstituted anthracenehexamine, substituted or unsubstituted tetracenehexamine, substituted or unsubstituted pentacenehexamine, substituted or unsubstituted phenanthrenehexamine, substituted or unsubstituted pyrenehexamine, substituted or unsubstituted chrysenehexamine, substituted or unsubstituted perylenehexamine, substituted or unsubstituted fluorenehexamine, substituted or unsubstituted coronenehexamine and substituted or unsubstituted ovalenehexamine.

13. The method for preparing a two-dimensional Ni-organic framework/rGO composite according to claim 10, wherein the substituted or unsubstituted C₆-C₃₀ arylhexamine is one selected from the following compounds 1-7:

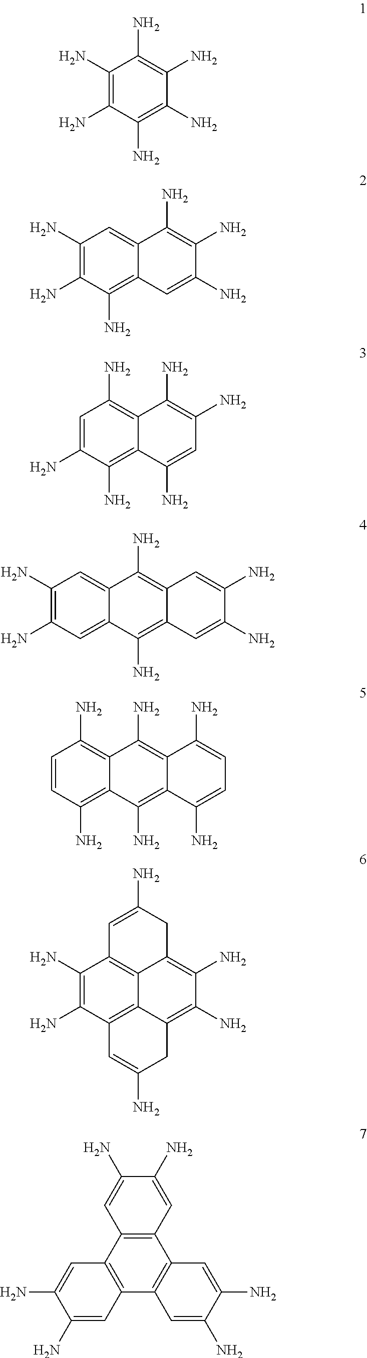

14. The method for preparing a two-dimensional Ni-organic framework/rGO composite according to claim 10, wherein, in the step (b), the two-dimensional Ni-organic framework/GO mixture dispersion is prepared by mixing the two-dimensional Ni-organic framework dispersion and the graphene oxide dispersion at a weight ratio of 1:0.3-1:1.5.

15. The method for preparing a two-dimensional Ni-organic framework/rGO composite according to claim 10, wherein, in the step (b), the mixing is performed by mechanical mixing or ultrasonic mixing.

16. The method for preparing a two-dimensional Ni-organic framework/rGO composite according to claim 10, wherein, in the step (c), the two-dimensional Ni-organic framework/GO composite is prepared into a thin film using membrane filter paper.

17. The method for preparing a two-dimensional Ni-organic framework/rGO composite according to claim 16, wherein the membrane filter paper is made of a material selected from cellulose acetate, nitrocellulose, cellulose ester, polytetrafluoroethylene, polysulfone, polyether sulfone, polyacrilonitrile, polyamide, polyimide, polyethylene, polypropylene, polyvinylidene fluoride (PVDF) and polyvinyl chloride.

18. The method for preparing a two-dimensional Ni-organic framework/rGO composite according to claim 10, wherein, in the step (d), the heat treatment is performed at 150-250° C.

19. The method for preparing a two-dimensional Ni-organic framework/rGO composite according to claim 18, wherein, in the step (d), the heat treatment is performed for 0.5-2 hours.

20. The method for preparing a two-dimensional Ni-organic framework/rGO composite according to claim 10, wherein, in the step (d), the heat treatment is performed under atmosphere of one selected from nitrogen gas, argon gas, nitrogen/hydrogen mixture gas and argon/hydrogen mixture gas.

21. A method for preparing an electrode for a secondary battery or a supercapacitor, comprising the method for preparing a two-dimensional Ni-organic framework/rGO composite according to claim 10.
